(19) United States
(12) Patent Application Publication
(10) Pub. No.: US 2014/0062999 A1
(43) Pub. Date: Mar. 6, 2014

(54) Display system and display control method thereof

(71) Applicants: Shen-Sian Syu, Shenzhen (CN); Yu-Yeh Chen, Shenzhen (CN)

(72) Inventors: Shen-Sian Syu, Shenzhen (CN); Yu-Yeh Chen, Shenzhen (CN)

(73) Assignee: SHENZHEN CHINA STAR OPTOELECTRONICS TECHNOLOGY CO., LTD., Guangdong (CN)

(21) Appl. No.: 13/642,540

(22) PCT Filed: Sep. 10, 2012
(86) PCT No.: PCT/CN2012/081180

§ 371 Date: Oct. 21, 2012

(30) Foreign Application Priority Data
Sep. 5, 2012 (CN) 201210325414.2

(51) Int. Cl. G06T 15/00

(52) U.S. Cl. 345/419

(57) ABSTRACT

The present invention discloses a display system and a display control method thereof. The display system comprises a display screen, a display controller, and a timing controller. The display controller comprises a 2D to 3D converter for converting image data with 2D format into converted image data with 3D format, and an encoding module for converting the converted image data with 3D format or first image data with 3D format into “2D image plus depth diagram” format data. The timing controller comprises a decoding module for converting the “2D image plus depth diagram” format data into decoded image data with 3D format or scaling the “2D image plus depth diagram” format data into scaled image data with 2D format suitable for outputting on the display screen. Accordingly, the present invention can reduce the required transmission line in order to reduce the production cost.

### BACKGROUND OF THE INVENTION

1. Field of the Invention

The present invention relates to the field of display technology, and more particularly to a display system and a display control method thereof.

2. Description of Related Art

Currently, the 3D display of the flat panel display has been more and more attention. In the transmission of image formats of 3D flat panel displays, if it require to transfer a complete picture signal to each of the left and right eyes, it will require a larger transmission power. As shown in FIG. 1, the 3D flat panel display 10 includes a display control terminal 20, a timing control terminal 30, a display screen 40, and a transmission line 50. Wherein, the bandwidth of the transmission line 50 is the bandwidth of image data with 2D format. When the control terminal 20 transmits image data with 3D format with 120 Hz to the timing control terminal 30, it require the bandwidth which is 2 times the bandwidth of the image data with 2D format, that is, the two times transmission line 50 required for transmitting the image data with 2D format. Therefore, when the resolution of the 3D flat panel display 10 is higher, the required transmission power is larger, and the number of the transmission line 50 will be increased, which increases the cost of production.

### SUMMARY OF THE INVENTION

The main technical problem solved by the present invention is to provide a display system and a display control method thereof such that the number of the transmission lines can be reduced in order to reduce production cost

In order to solve the above-mentioned technical problem, a technical solution provided by the present invention is: a display system comprising:

a display screen;

a display controller comprising a 2D to 3D converter for converting image data with 2D format into converted image data with 3D format; an encoding module for converting the converted image data with 3D format or first image data with 3D format into “2D image plus depth diagram” format data; and

a timing controller for receiving image data with 2D format or the “2D image plus depth diagram” format data from the display controller and comprising a decoding module for converting the “2D image plus depth diagram” format data into decoded image data with 3D format or scaling the “2D image plus depth diagram” format data into scaled image data with 2D format suitable for outputting on the display screen, wherein the display screen receives the scaled image data with 2D format or the decoded image data with 3D format from the timing controller and displays correspondingly;

wherein, when the first image data with 3D format is inputted to the display controller, and it requires displaying the scaled image data with 2D format on the display screen, the encoding module receives the first image data with 3D format and encodes the first image data with 3D format to form the “2D image plus depth diagram” format data and transmits it to the decoding module, and the decoding module scales the “2D image plus depth diagram” format data into the scaled image data with 2D format suitable for outputting on the display screen and transmits it to the display screen;

when the first image data with 3D format is inputted to the display controller and it requires displaying the decoded image data with 3D format on the display screen, the encoding module receives the first image data with 3D format and encodes the first image data with 3D format to form the “2D image plus depth diagram” format data and transmits it to the decoding module, and the decoding module decodes the “2D image plus depth diagram” format data into the decoded image data with 3D format and transmits it to the display screen.

Wherein, when the image data with 2D format is inputted to the display controller, and it requires displaying the decoded image data with 3D format on the display screen: the 2D to 3D converter converts the image data with 2D format into the converted image data with 3D format and transmit it to the encoding module, and the encoding module encodes the converted image data with 3D format to form the “2D image plus depth diagram” format data and transmit it to the decoding module, and the decoding module decodes the “2D image plus depth diagram” format data into the decoded image data with 3D format and transmit it to the display screen.

Wherein, when the image data with 2D format is inputted to the display controller and it requires displaying the image data with 2D format on the display screen: the display controller transmits the image data with 2D format to the timing controller directly, and the timing controller transmits the image data with 2D format to the display screen.

Wherein, when the “2D image plus depth diagram” format data is inputted to the display controller, and it requires to display the scaled image data with 2D format on the display screen: the display controller transmits the “2D image plus depth diagram” format data to the timing controller, and the decoding module scales the “2D image plus depth diagram” format data into the scaled image data with 2D format suitable for outputting on the display screen and transmits it to the display screen.

Wherein, when the “2D image plus depth diagram” format data is inputted to the display controller, and it requires displaying the decoded image data with 3D format on the display screen: the display controller transmits the “2D image plus depth diagram” format data to the timing controller, and the decoding module decodes the “2D image plus depth diagram” format data into the decoded image data with 3D format and transmits it to the display screen.

Wherein, the display system further comprises a transmission line and a flexible circuit board, and the display controller connects to the timing controller through the transmission line, and the timing controller connects to the display screen through the flexible circuit board.

In order to solve the above-mentioned technical problem, another technical solution provided by the present invention is: a display system comprising:

a display screen;

a display controller comprising a 2D to 3D converter for converting image data with 2D format into converted image data with 3D format; an encoding module for converting the converted image data with 3D format or first image data with 3D format into “2D image plus depth diagram” format data; and

a timing controller for receiving image data with 2D format or the “2D image plus depth diagram” format data from the display controller and comprising a decoding module for converting the “2D image plus depth diagram” format data into decoded image data with 3D format or scaling the “2D image plus depth diagram” format data into scaled image data with 2D format suitable for outputting on the display screen, wherein the display screen receives the scaled image data with 2D format or the decoded image data with 3D format from the timing controller and displays correspondingly.

Wherein, when the image data with 2D format is inputted to the display controller, and it requires displaying the decoded image data with 3D format on the display screen: the 2D to 3D converter converts the image data with 2D format into the converted image data with 3D format and transmit it to the encoding module, and the encoding module encodes the converted image data with 3D format to form the “2D image plus depth diagram” format data and transmit it to the decoding module, and the decoding module decodes the “2D image plus depth diagram” format data into the decoded image data with 3D format and transmit it to the display screen.

Wherein, when the image data with 2D format is inputted to the display controller and it requires displaying the image data with 2D format on the display screen: the display controller transmits the image data with 2D format to the timing controller directly, and the timing controller transmits the image data with 2D format to the display screen.

Wherein, when the first image data with 3D format is inputted to the display controller, and it requires displaying the scaled image data with 2D format on the display screen, the encoding module receives the first image data with 3D format and encodes the first image data with 3D format to form the “2D image plus depth diagram” format data and transmits it to the decoding module, and the decoding module scales the “2D image plus depth diagram” format data into the scaled image data with 2D format suitable for outputting on the display screen and transmits it to the display screen.

Wherein, when the first image data with 3D format is inputted to the display controller and it requires displaying the decoded image data with 3D format on the display screen, the encoding module receives the first image data with 3D format and encodes the first image data with 3D format to form the “2D image plus depth diagram” format data and transmits it to the decoding module, and the decoding module decodes the “2D image plus depth diagram” format data into the decoded image data with 3D format and transmits it to the display screen.

Wherein, when the “2D image plus depth diagram” format data is inputted to the display controller, and it requires displaying the scaled image data with 2D format on the display screen: the display controller transmits the “2D image plus depth diagram” format data to the timing controller, and the decoding module scales the “2D image plus depth diagram” format data into the scaled image data with 2D format suitable for outputting on the display screen and transmits it to the display screen.

Wherein, when the “2D image plus depth diagram” format data is inputted to the display controller, and it requires displaying the decoded image data with 3D format on the display screen: the display controller transmits the “2D image plus depth diagram” format data to the timing controller, and the decoding module decodes the “2D image plus depth diagram” format data into the decoded image data with 3D format and transmits it to the display screen.

Wherein, the display system further comprises a transmission line and a flexible circuit board, and the display controller connects to the timing controller through the transmission line, and the timing controller connects to the display screen through the flexible circuit board.

In order to solve the above-mentioned technical problem, another technical solution provided by the present invention is: a display control method comprising:

converting first image data with 3D format into “2D image plus depth diagram” format data in a display controller, and transmitting the “2D image plus depth diagram” format data to a timing controller; converting the “2D image plus depth diagram” format data into decoded image data with 3D format in the timing controller, and transmitting it to the display screen for displaying.

Wherein, when image data with 2D format is inputted to the display controller, converting the image data with 2D format into converted image data with 3D format, and then converting the converted image data with 3D format into “2D image plus depth diagram” format data.

The beneficial effect of the present invention is: comparing to the prior art, the present invention provides a display system comprising a display screen, a display controller, and a timing controller. The display controller of the present invention converts the first image data with 3D format or the converted image data with 3D format is converted into the “2D image plus depth diagram” format data, and then transmitting it to the timing controller. The timing controller converts the “2D image plus depth diagram” format data into the decoded image data with 3D format or scales the “2D image plus depth diagram” format data into the scaled image data with 2D format suitable for outputting on the display screen. The present invention also provides a display control method that uses the display system. Because the occupied bandwidth of the “2D image plus depth diagram” format data is smaller than the occupied bandwidth of the image data with 3D format, the present invention can reduce the required transmission line by transmitting the data after the image data with 3D format is converted into the “2D image plus depth diagram” format data, which reduces the production cost.

### BRIEF DESCRIPTION OF THE DRAWINGS

FIG. 1 is a schematic view illustrating a display system according to the prior art;

FIG. 2 is a schematic view illustrating a display system according to an embodiment of the present invention;

FIG. 3 is a schematic view illustrating a “2D image plus depth diagram” format data according to the present invention:

FIG. 4 is a flowchart illustrating a display control method according to an embodiment of the present invention;

FIG. 5 is a flowchart illustrating the display control method according to a specific embodiment of the present invention;

FIG. 6 is a flowchart illustrating the display control method according to another specific embodiment of the present invention; and

FIG. 7 is a flowchart illustrating the display control method according to another specific embodiment of the present invention.

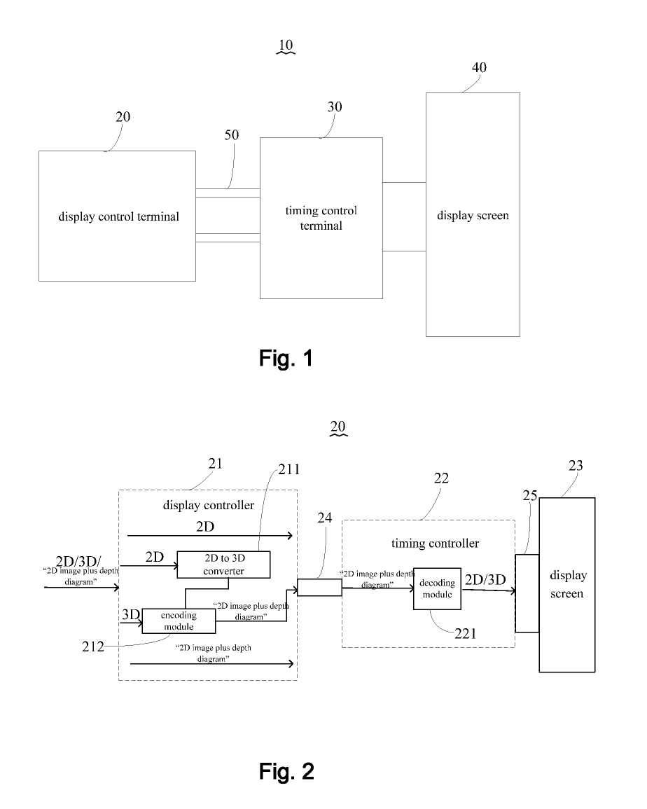

### DETAILED DESCRIPTION OF THE PREFERRED EMBODIMENT

With reference to FIG. 2, it is a schematic view illustrating a display system according to an embodiment of the present invention. As shown in FIG. 2, a display system 20 of the present invention includes a display controller 21, a timing controller 22, and a display screen 23.

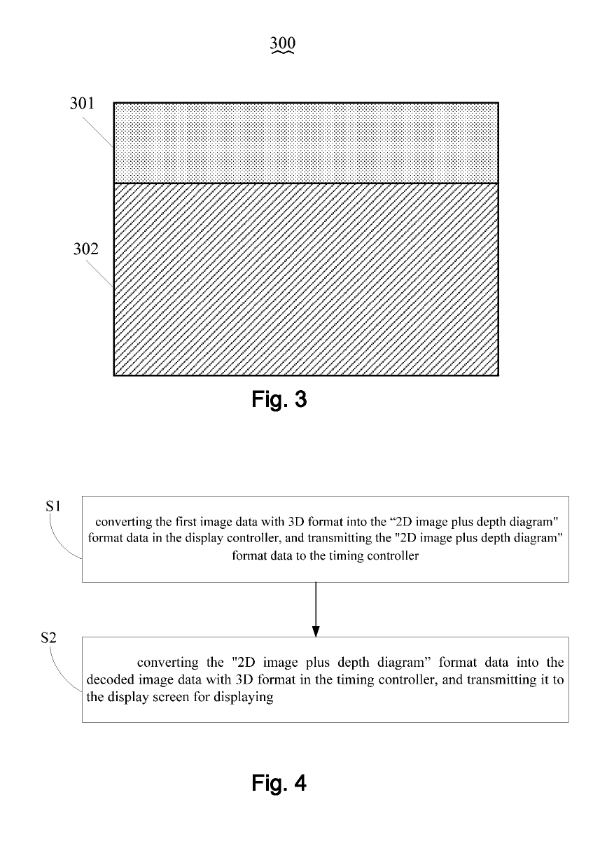

In the present embodiment, the display controller 21 includes a 2D to 3D converter 211 and an encoding module 212. Wherein, the 2D to 3D converter 211 is for converting image data with 2D format into converted image data with 3D format. The encoding module 212 is for converting first image data with 3D format or the converted image data with 3D format into “2D image plus depth diagram” format data. Wherein, the data structure of the “2D image plus depth diagram” format data is shown in FIG. 3.

Please also refer to FIG. 3. In FIG. 3, the “2D image plus depth diagram” format data 300 includes depth diagram format data 301 and image data with 2D format 302. The data size of the “2D image plus depth diagram” format data 300 is the data size of one picture, and the proportion of the depth diagram format data 301 in the “2D image plus depth diagram” format data 300 affects the quality of the 3D image. The proportion of the depth diagram format data 301 in the “2D image plus depth diagram” format data 300 within a certain range is higher, the quality of the 3D image is better.

In the present embodiment, the timing controller 22 receives image data with 2D format or the “2D image plus depth diagram” format data from the display controller 21. Wherein, the timing controller 22 includes a decoding module 221, and the decoding module 221 is for converting the “2D image plus depth diagram” format data into decoded image data with 3D format. Specifically, enlarging each of the image data with 2D format 302 and the depth diagram format data 301 in the “2D image plus depth diagram” format data into the data size of one picture, and then converting them into the decoded image data with 3D format.

It is worth noting that the decoding module 221 may also scale the “2D image plus depth diagram” format data into scaled image data with 2D format suitable for outputting on the display screen 23 according to requirement.

The display screen 23 receives the image data with 2D format or image data with 3D format from the timing controller 22, and correspondingly displays.

In this embodiment, the display system 20 further includes a transmission line 24 and a flexible circuit board 25. Wherein, the display controller 21 connects to the timing controller 22 through the transmission line 24, and the timing controller 22 connects to the display screen 23 through the flexible circuit board 25.

Therefore, the display controller 21 may be used to convert the image data with 2D format into the converted image data with 3D format, and convert the converted image data with 3D format into the “2D image plus depth diagram” format data. The timing controller 22 is for converting “2D image plus depth diagram” format data into the decoded image data with 3D format or the scaled image data with 2D format according to requirement.

It is worth noting that the source of the data inputting to the display controller 21 may be various formats, and it displays the scaled image data with 2D format or the decoded image data with 3D format according to requirement. Therefore, according to the different format data of the source and the different data to be displayed on the display screen 23, the display controller 21 and the timing controller 22 proceeds different operations, the specific work process is as following:

When the image data with 2D format is inputted to the display controller 21, and it requires displaying the decoded image data with 3D format on the display screen 23:

The 2D to 3D converter 211 converts the image data with 2D format into the converted image data with 3D format and transmit it to the encoding module 212. The encoding module 212 encodes the converted image data with 3D format to form the “2D image plus depth diagram” format data and transmit it to the decoding module 221 through the transmission line 24. Then the decoding module 221 decodes the “2D image plus depth diagram” format data to the decoded image data with 3D format and transmit it through the flexible circuit board 25 to the display screen 23 for displaying.

When the image data with 2D format is inputted to the display controller 21, and it requires displaying the image data with 2D format on the display screen 23:

The 2D to 3D converter 211, the encoding module 212, and decoding module 221 stop operating, and the display controller 21 transmit the image data with 2D format to the timing controller 22 directly through the transmission line 24. And the timing controller 22 transmits the image data with 2D format to the display screen 23 through the flexible circuit board 25.

The 2D to 3D converter 211 stops operating, and the encoding module 212 encodes the first image data with 3D format to form the “2D image plus depth diagram” format data and transmit it to the decoding module 221 through the transmission line 24. The decoding module 221 scales “2D image plus depth diagram” format data into the scaled image data with 2D format suitable for outputting on the display screen 23 and transmits it to the display screen 23 through the flexible circuit board 25.

When the first image data with 3D) format is inputted to the display controller 21, and it requires displaying the decoded image data with 3D format on the display screen 23:

The 2D to 3D converter 211 stops operating, and the encoding module 212 encodes the first image data with 3D format to form the “2D image plus depth diagram” format data and transmits it to the decoding module 221 through the transmission line 24. The decoding module 221 decodes the “2D image plus depth diagram” format data into the decoded image data with 3D format and transmits it to the display screen 23 through the flexible circuit board 25.

When the “2D image plus depth diagram” format data is inputted to the display controller 21, and it requires to display the scaled image data with 2D format on the display screen 23:

The 2D to 3D converter 211 and the encoding module 212 stop operating, and the display controller 21 transmits the “2D image plus depth diagram” format data to the timing controller 22 through the transmission line 24. Then the decoding module 221 scales the “2D image plus depth diagram” format data into the scaled image data with 2D format suitable for outputting on the display screen 23 and transmits it to the display screen 23 through the flexible circuit board 25.

When the “2D image plus depth diagram” format data is inputted to the display controller 21, and it requires to display the decoded image data with 3D format on the display screen 23:

The 2D to 3D converter 211 and the encoding module 212 stop operating, and the display controller 21 transmits the “2D image plus depth diagram” format data to the timing controller 22 through the transmission line 24. Then the decoding module 221 decodes the “2D image plus depth diagram” format data into the decoded image data with 3D format and transmits it to the display screen 23 through the flexible circuit board 25.

Accordingly, the data transmitted from the display controller 21 to the timing controller 22 is the image data with 2D format or the “2D image plus depth diagram” format data having a smaller bandwidth. Therefore, it reduces the number of the transmission lines 24 in order to reduce the production cost.

With reference to FIG. 4. FIG. 4 is a flowchart illustrating a display control method according to an embodiment of the present invention. As shown in FIG. 4, the display control method comprising the following steps:

Step S1: converting the first image data with 3D format into the “2D image plus depth diagram” format data in the display controller, and transmitting the “2D image plus depth diagram” format data to the timing controller;

Wherein, in the step S1, it further includes a step of converting the image data with 2D format into the converted image data with 3D format.

Step S2: converting the “2D image plus depth diagram” format data into the decoded image data with 3D format in the timing controller, and transmitting it to the display screen for displaying.

Wherein, in the step S2, it further includes a step of scaling the “2D image plus depth diagram” format data into the scaled image data with 2D format suitable for outputting on the display screen.

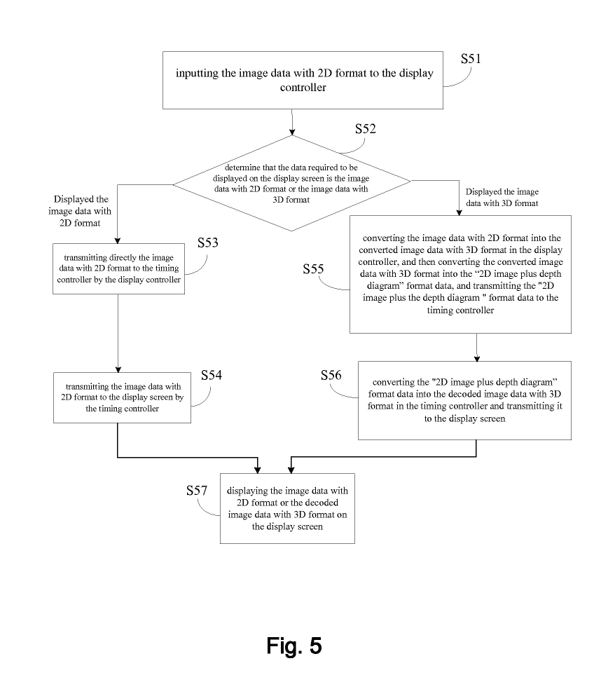

In the embodiment of the present invention, the specific display control method according to the format data inputted to the display controller and the format data displayed on the display screen are shown in FIG. 5 to FIG. 7.

With reference to FIG. 5, it is a flowchart illustrating the display control method according to a specific embodiment of the present invention. As shown in FIG. 5, which comprises the following steps:

Step S51: inputting the image data with 2D format to the display controller;

Step S52: determine that the data required to be displayed on the display screen is the image data with 2D format or the image data with 3D format;

In step S52, if the determination result is “displayed the image data with 2D format”, then jump to step S53, whereas if the determination result is “displayed the image data with 3D format”, then jump to S55;

Step S53: transmitting directly the image data with 2D format to the timing controller by the display controller;

In step S53, the display controller stops converting and directly transmitting the image data with 2D format inputted in the step $51 to the timing controller:

Step S54: transmitting the image data with 2D format to the display screen by the timing controller;

In step S54, the timing controller stops converting and directly transmits the image data with 2D format transmitted from the step S53 to the display screen;

Step S55: converting the image data with 2D format into the converted image data with 3D format in the display controller, and then converting the converted image data with 3D format into the “2D image plus depth diagram” format data, and transmitting the “2D image plus the depth diagram” format data to the timing controller;

Step S56: converting the “2D image plus depth diagram” format data into the decoded image data with 3D format in the timing controller and transmitting it to the display screen;

Step S57: displaying the image data with 2D format or the decoded image data with 3D format on the display screen;

In the step S57, if the input data of the display screen is the image data with 2D format transmitted from the step S54, displaying the image data with 2D format; if the input data of the display screen is the decoded image data with 3D format transmitted from the step S56, displaying the decoded 3D image format.

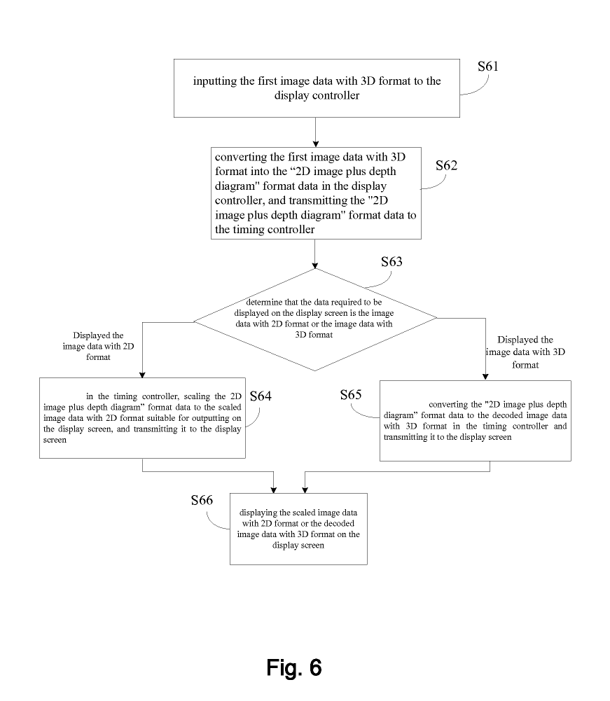

Therefore, FIG. 5 achieve the display control method when the data inputted to the display controller is the image data with 2D format. It is noteworthy that when the inputted data is other image format data such as the image data with 3D format. The display control method is shown in FIG. 6.

With reference to FIG. 6, it is a flowchart illustrating the display control method according to another specific embodiment of the present invention, which comprises the following steps:

Step S61: inputting the first image data with 3D format to the display controller;

Step S62: converting the first image data with 3D format into the “2D image plus depth diagram” format data in the display controller, and transmitting the “2D image plus depth diagram” format data to the timing controller;

Step S63: determine that the data required to be displayed on the display screen is the image data with 2D format or the image data with 3D format;

In the step S63, if the determination result is “displayed the image data with 2D format”, then jump to the step S64, whereas if the determination result is “displayed the image data with 3D format, then jump to S65;

Step S64: in the timing controller, scaling the 2D image plus depth diagram” format data to the scaled image data with 2D format suitable for outputting on the display screen, and transmitting it to the display screen;

Step S65: converting the “2D image plus depth diagram” format data to the decoded image data with 3D format in the timing controller and transmitting it to the display screen; and

Step S66: displaying the scaled image data with 2D format or the decoded image data with 3D format on the display screen.

In the step S66, if the input data of the display screen is the scaled image data with 2 format transmitted from the step S64, displaying the scaled image data with 2D format; if the input data of the display screen is the decoded image data with 3D format transmitted from the step S65, displaying the decoded image data with 3D format.

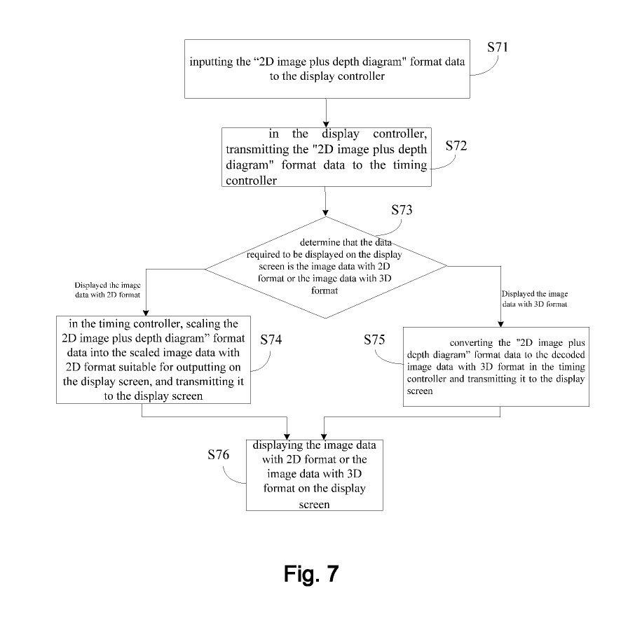

Therefore, FIG. 6 achieve the display control method when the data inputted to the display controller is the image data with 3D format. It is noteworthy that when the inputted data is other image format data such as the “2D image plus depth diagram”. The display control method is shown in FIG. 7.

With reference to FIG. 7, it is a flowchart illustrating the display control method according to another specific embodiment of the present invention. As shown in FIG. 7, which comprises the following steps:

Step S71: inputting the “2D image plus depth diagram” format data to the display controller;

Step S72: in the display controller, transmitting the “2D image plus depth diagram” format data to the timing controller;

In the step S72, the display controller stops converting and directly transmits the inputted “2D image plus depth diagram” format data to the timing controller;

Step S73: determine that the data required to be displayed on the display screen is the image data with 2D format or the image data with 3D format:

In step S73, if the determination result is “displayed the image data with 2D format”, then jump to step S74, whereas if the determination result is “displayed the image data with 3D format”, then jump to S75;

Step S74: in the timing controller, scaling the 2D image plus depth diagram” format data into the scaled image data with 2D format suitable for outputting on the display screen, and transmitting it to the display screen;

Step S75: converting the “2D image plus depth diagram” format data to the decoded image data with 3D format in the timing controller and transmitting it to the display screen;

Step S76: displaying the image data with 2D format or the image data with 3D format on the display screen;

In the step S76, if the input data of the display screen is the scaled image data with 2D format transmitted from the step S74, displaying the scaled image data with 2D format: if the input data of the display screen is the decoded image data with 3D format transmitted from the step S75, displaying the decoded image data with 3D format.

In summary, the present invention utilizes that the first image data with 3D format or the converted image data with 3D format is converted into the “2D image plus depth diagram” format data, and then transmitting it to the timing controller. The timing controller converts the “2D image plus depth diagram” format data into the decoded image data with 3D format or scales the “2D image plus depth diagram” format data into the scaled image data with 2D format suitable for outputting on the display screen. Because the occupied bandwidth of the “2D image plus depth diagram” format data is smaller than the occupied bandwidth of the image data with 3D format, the present invention can reduce the required transmission line by transmitting the data after the image data with 3D format is converted into the “2D image plus depth diagram” format data, which reduces the production cost.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A display system comprising:
a display screen;
a display controller comprising a 2D to 3D converter for converting image data with 2D format into converted image data with 3D format; an encoding module for converting the converted image data with 3D format or first image data with 3D format into “2D image plus depth diagram” format data; and
a timing controller for receiving image data with 2D format or the “2D image plus depth diagram” format data from the display controller and comprising a decoding module for converting the “2D image plus depth diagram” format data into decoded image data with 3D format or scaling the “2D image plus depth diagram” format data into scaled image data with 2D format suitable for outputting on the display screen, wherein the display screen receives the scaled image data with 2D format or the decoded image data with 3D format from the timing controller and displays correspondingly;
wherein, when the first image data with 3D format is inputted to the display controller, and it requires displaying the scaled image data with 2D format on the display screen, the encoding module receives the first image data with 3D format and encodes the first image data with 3D format to form the “21 image plus depth diagram” format data and transmits it to the decoding module, and the decoding module scales the “2D image plus depth diagram” format data into the scaled image data with 2D format suitable for outputting on the display screen and transmits it to the display screen;
when the first image data with 3D format is inputted to the display controller and it requires displaying the decoded image data with 3D format on the display screen, the encoding module receives the first image data with 3D format and encodes the first image data with 3D format to form the “2D image plus depth diagram” format data and transmits it to the decoding module, and the decoding module decodes the “2D image plus depth diagram” format data into the decoded image data with 3D format and transmits it to the display screen.

2. The display system according to claim 1, wherein, when the image data with 2D format is inputted to the display controller and it requires displaying the decoded image data with 3D format on the display screen: the 2D to 3D converter converts the image data with 2D format into the converted image data with 3D format and transmit it to the encoding module, and the encoding module encodes the converted image data with 3D format to form the “2D image plus depth diagram” format data and transmit it to the decoding module, and the decoding module decodes the “2D image plus depth diagram” format data into the decoded image data with 3D format and transmit it to the display screen.

3. The display system according to claim 1, wherein, when the image data with 2D format is inputted to the display controller and it requires displaying the image data with 2D format on the display screen: the display controller transmits the image data with 2D format to the timing controller directly, and the timing controller transmits the image data with 2D format to the display screen.

4. The display system according to claim 1, wherein, when the “2D image plus depth diagram” format data is inputted to the display controller, and it requires displaying the scaled image data with 2D format on the display screen: the display controller transmits the “2D image plus depth diagram” format data to the timing controller, and the decoding module scales the “2D image plus depth diagram” format data into the scaled image data with 2D format suitable for outputting on the display screen and transmits it to the display screen.

5. The display system according to claim 1, wherein, when the “2D image plus depth diagram” format data is inputted to the display controller, and it requires displaying the decoded image data with 3D format on the display screen: the display controller transmits the “2D image plus depth diagram” format data to the timing controller, and the decoding module decodes the “2D image plus depth diagram” format data into the decoded image data with 3D format and transmits it to the display screen.

6. The display system according to claim 1, wherein, the display system further comprises a transmission line and a flexible circuit board, and the display controller connects to the timing controller through the transmission line, and the timing controller connects to the display screen through the flexible circuit board.

7. A display system comprising:
a display screen;
a display controller comprising a 2D to 3D converter for converting image data with 2D format into converted image data with 3D format; an encoding module for converting the converted image data with 3D format or first image data with 3D format into “2D image plus depth diagram” format data; and
a timing controller for receiving image data with 2D format or the “2D image plus depth diagram” format data from the display controller and comprising a decoding module for converting the “2D image plus depth diagram” format data into decoded image data with 3D format or scaling the “2D image plus depth diagram” format data into scaled image data with 2D format suitable for outputting on the display screen, wherein the display screen receives the scaled image data with 2D format or the decoded image data with 3D format from the timing controller and displays correspondingly.

8. The display system according to claim 7, wherein, when the image data with 2D format is inputted to the display controller and it requires displaying the decoded image data with 3D format on the display screen: the 2D to 3D converter converts the image data with 2D format into the converted image data with 3D format and transmit it to the encoding module, and the encoding module encodes the converted image data with 3D format to form the “2D image plus depth diagram” format data and transmit it to the decoding module, and the decoding module decodes the “2D image plus depth diagram” format data into the decoded image data with 3D format and transmit it to the display screen.

9. The display system according to claim 7, wherein, when the image data with 2D format is inputted to the display controller and it requires displaying the image data with 2D format on the display screen: the display controller transmits the image data with 2D format to the timing controller directly, and the timing controller transmits the image data with 2D format to the display screen.

10. The display system according to claim 7, wherein, when the first image data with 3D format is inputted to the display controller, and it requires displaying the scaled image data with 2D format on the display screen, the encoding module receives the first image data with 3D format and encodes the first image data with 3D format to form the “2D image plus depth diagram” format data and transmits it to the decoding module, and the decoding module scales the “2D image plus depth diagram” format data into the scaled image data with 2D format suitable for outputting on the display screen and transmits it to the display screen.

11. The display system according to claim 7, wherein, when the first image data with 3D format is inputted to the display controller and it requires displaying the decoded image data with 3D format on the display screen, the encoding module receives the first image data with 3D format and encodes the first image data with 3D format to form the “2D image plus depth diagram” format data and transmits it to the decoding module, and the decoding module decodes the “2D image plus depth diagram” format data into the decoded image data with 3D format and transmits it to the display screen.

12. The display system according to claim 7, wherein, when the “2D image plus depth diagram” format data is inputted to the display controller, and it requires displaying the scaled image data with 2D format on the display screen: the display controller transmits the “2D image plus depth diagram” format data to the timing controller, and the decoding module scales the “2D image plus depth diagram” format data into the scaled image data with 2D format suitable for outputting on the display screen and transmits it to the display screen.

13. The display system according to claim 7, wherein, when the “2D image plus depth diagram” format data is inputted to the display controller, and it requires displaying the decoded image data with 3D format on the display screen: the display controller transmits the “2D image plus depth diagram” format data to the timing controller, and the decoding module decodes the “2D image plus depth diagram” format data into the decoded image data with 3D format and transmits it to the display screen.

14. The display system according to claim 7, wherein, the display system further comprises a transmission line and a flexible circuit board, and the display controller connects to the timing controller through the transmission line, and the timing controller connects to the display screen through the flexible circuit board.

15. A display control method comprising:
converting first image data with 3D format into “2D image plus depth diagram” format data in a display controller, and transmitting the “2D image plus depth diagram” format data to a timing controller;
converting the “2D image plus depth diagram” format data into decoded image data with 3D format in the timing controller, and transmitting it to the display screen for displaying.

16. The display control method according to claim 15, wherein, when image data with 2D format is inputted to the display controller, converting the image data with 2D format into converted image data with 3D format, and then converting the converted image data with 3D format into “2D image plus depth diagram” format data.
